(19) United States
(12) Patent Application Publication
(10) Pub. No.: US 2026/0300528 A1
(43) Pub. Date: Oct. 1, 2026

(54) MULTI-CLOUD DATA SECURITY ENGINE WITH CONTEXTUAL ENCRYPTION AND LOSS IMPACT-BASED ASSESSMENT

(71) Applicant: DELL PRODUCTS L.P., Round Rock, TX (US)

(72) Inventors: Avinash Kumar, Patna (IN); Parminder Singh Sethi, Ludhiana (IN); Praveen Kumar, Noida (IN)

(21) Appl. No.: 19/096,045

(22) Filed: Mar. 31, 2025

(51) Int. Cl. G06F 21/62; G06F 21/60

(52) U.S. Cl. CPC G06F 21/6227; G06F 21/602; G06F 21/606

(57) ABSTRACT

An information handling system determines a sensitivity level for cloud resources, determines an encryption level for each of the cloud resources based on the sensitivity level, and encrypts data transfers between the information handling system and each of the cloud resources based on each cloud resource’s encryption level.

### FIELD OF THE DISCLOSURE

This disclosure relates to information handling systems, and more particularly relates to providing a multi-cloud data security engine with contextual encryption and loss impact-based assessment in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may determine a sensitivity level for cloud resources, determine an encryption level for each of the cloud resources based on the sensitivity level, and encrypt data transfers between the information handling system and each of the cloud resources based on each cloud resource’s encryption level.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an information handling system according to an embodiment of the present disclosure;

FIG. 2 is a flowchart illustrating a method for providing a multi-cloud data security engine with contextual encryption and loss impact-based assessment according to an embodiment of the present disclosure; and

FIG. 3 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

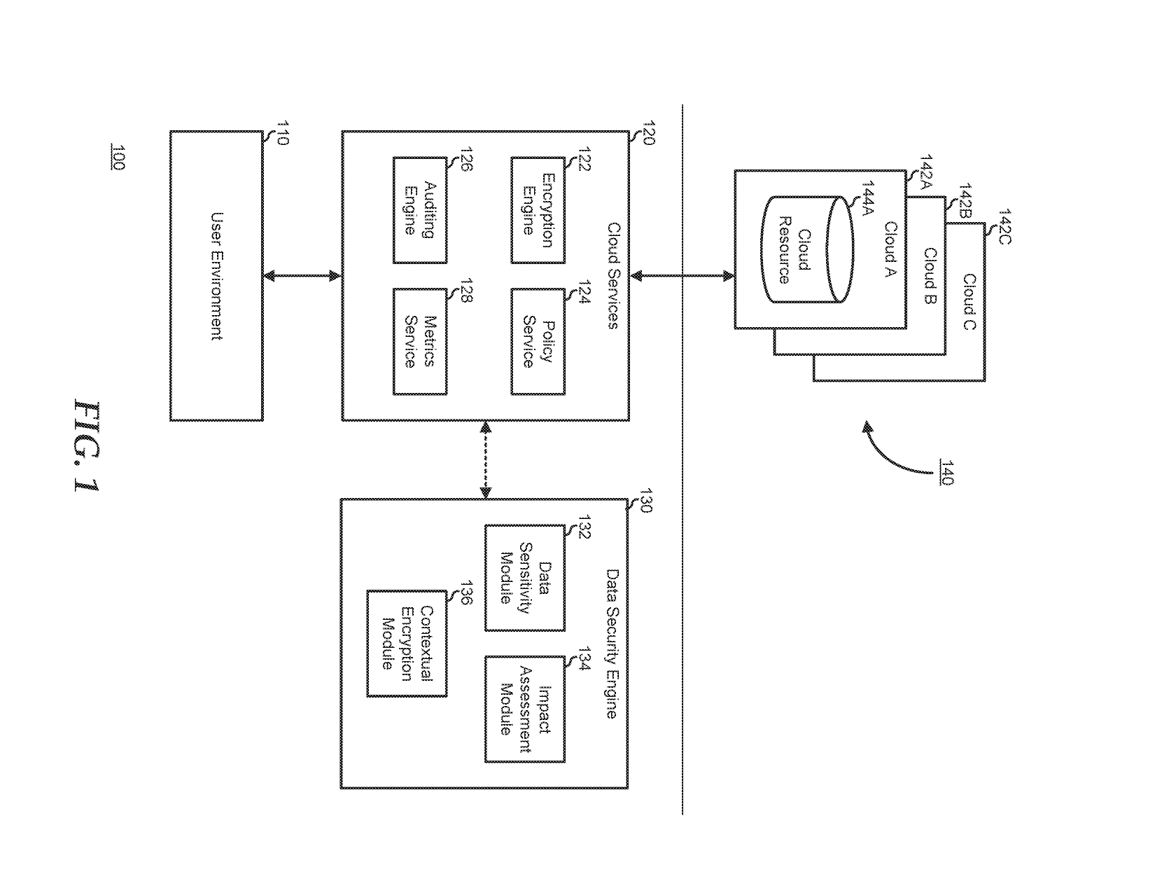

FIG. 1 illustrates an information handling system 100 and a multi-cloud environment 140. Information handling system 100 represents a set of computing functions which may be included in a single device such as a laptop computer or mobile computing device like a smartphone or tablet device, a desktop or workstation computer, a slim client device, or a remote processing environment instantiated on such a device or computer, or the like. The set of computing functions may likewise be included in a distributed set of devices, such as where a single device is associated with a particular user or set of users and where such a device is associated with various connected services, such as proxy or gateway services of a corporate network, services provided in a cloud-based environment, or the like. In this regard, the elements of information handling system 100 may be instantiated within a single location or within multiple connected locations, as needed or desired. Information handling system 100 includes a user environment 110, cloud services 120, and a data security engine 130.

User environment 110 is characterized by the fact that the user environment can be utilized to create, modify, delete or otherwise utilize various content items stored on multi-cloud environment 140, or to access the functions and features of various devices associated with the multi-cloud environment, as needed or desired. Multi-cloud environment 140 includes multiple user-accessible clouds 142A, 142B, and 142C. Each one of clouds 142A, 142B, and 142C includes a respective cloud resource 144A, 144B, and 144C. Cloud resources 144A, 144B, and 144C represent content items, devices, services, utilities, or the like, or a combination thereof, as needed or desired. Clouds 142A, 142B, and 142C, and particularly cloud resources 144A, 144B, and 144C, are typified by the fact that access is protected, such as by requiring a user to log in or otherwise authenticate their access credentials, by applying encoding to the contents or communications between the clouds or cloud resources and user environment 110, or by other protection mechanisms, as needed or desired.

Cloud services 120 represent various processes and services that are utilized by information handling system 100 to monitor, manage, and maintain the connected access by user environment 110 to mutli-cloud environment 140. As such, cloud services 120 includes an encryption engine 122, a policy service 124, an auditing engine 126, and an access metrics monitoring service 128. Encryption engine 122 provides encryption and decryption services for the communications between user environment 110 and multi-cloud environment 140, including negotiating encryption levels to be applied to the communications, and the like. In a particular embodiment, encryption engine 122 performs the actual encryption and decryption of the communications between user environment 110 and multi-cloud environment 140. In another embodiment, the encryption and decryption functions are provided by user environment 110, but the management of the encryption levels and the like are provided by the encryption engine. Note further that the data communicated between user environment 110 and multi-cloud environment 140 may be encrypted, either by the user environment, by the various clouds 142A, 142B, or 142C that are the target of the data communication, or by a combination thereof, as needed or desired. Encryption engine 122 may receive directions as to encryption levels for each of clouds 142A, 142B, and 142C, and cloud resources 144A, 144B, and 144C from data security engine 130, as described further below.

Policy service 124 monitors, manages, and maintains the authentication between user environment 110 and clouds 142A, 142B, and 142C, as needed or desired. Policy service 124 may further provide policy information to data security engine 130, as described further below. Auditing engine 126 monitors, manages, and maintains the communications between user environment 110 and multi-cloud environment 140 to ensure that access restrictions associated with clouds 142A, 142B, and 142C, and cloud resources 144A, 144B, and 144C are in compliance with various policies, regulations, or the like. For example, cloud 142A may be associated with data or devices that must comply with a particular data retention and access regulation, such as the General Data Protection Regulation (GDPR), the California Consumer Privacy Act (CCPA), the Personal Information Protection and Electronic Documents Act (PIPEDA), the Health Insurance Portability and Accountability Act (HIPAA), or the like. Auditing engine 126 may further provide auditing and compliance information to data security engine 130, as described further below. Access metrics monitoring service 128 monitors access metrics for the content and devices of multi-cloud environment 140. For example, access metrics monitoring service 128 may monitor the frequency of access to the content and devices of multi-cloud environment 140, the bandwidth utilization for clouds 142A, 142B, or 142C, or cloud resources 144A, 144B, or 144C, or the like. Access metrics monitoring service 128 may further provide access metrics information to data security engine 130, as described further below.

It has been understood by the inventors of the present disclosure, that the access by a user environment to a multi-cloud environment is typically provided on an ad hoc basis, where each cloud has a separate and distinct access protection regime, or may be provided based upon a most restrictive protection regime necessitated by an operator of the information handling system and the user environment. In the first case of ad hoc protection regimes, the content and devices of on cloud may be more securely protected than the content and devices of a next cloud. However, the content and devices of each cloud may have differing sensitivity levels. That is, the content and devices of the first cloud may be protected by a weaker protection regime but may be highly sensitive, while the content and devices of a second cloud may be protected by a stronger protection regime but may be less sensitive. Such a mismatch between content and device sensitivity and the protection regime associated with the content and devices results in mismatched, and hence inefficient, amounts of processing resources being used to provide the protection, and in potential exposure of sensitive content and devices to malicious activities. In the second case of providing a most restrictive protection regime by the information handling system for all clouds and cloud resources, excess processing resources may be expended protecting less sensitive content and devices.

Data security engine 130 operates to dynamically assess the sensitivity of the content and devices of multi-cloud environment 140, and to individually adjust the access requirements and encryption strength for clouds 142A, 142B, and 142C, and cloud resources 144A, 144B, and 144C based upon the assessment. Data security engine 130 includes a data sensitivity module 132, an impact assessment module 134, and a contextual encryption module 136. Data sensitivity module 130 assesses the sensitivity of data in each of clouds 142A, 142B, and 142C by analyzing various factors, such as the data types, usage patterns, regulatory requirements, or the like. Impact assessment module 134 evaluates the potential consequences of data loss or exposure. In particular, impact assessment module 134 utilizes an impact factor analysis in combination with a data classification to group data into categories based on its importance and sensitivity. The classification is utilized by impact assessment module 134 to prioritize the encryption efforts and resource allocation to provide enhanced data security designed to each cloud’s specific requirements.

Contextual encryption module 136 utilizes inputs from data sensitivity module 132 and impact assessment module 134 to determine the appropriate level of encryption for each of cloud resources 144A, 144B, and 144C. In particular, contextual encryption module 136 employs a Natural Language Processing (NLP) model, such as a Named-Entity Recognition (NER) model or a Named-Entity Linkage (NEL) model, to identify sensitive data that requires stronger encryption. Contextual encryption module 136 then directs encryption engine 122 to adjust the encryption strength of cloud resources 144A, 144B, and 144C based on the sensitivity and the criticality of the particular cloud resources, thereby ensuring optimal security without compromising performance in multi-cloud environment 140. Policy service 124, auditing engine 126, and metrics service 128 provide information to data security engine 130. In particular, data sensitivity module 132 and impact assessment module 134 utilize the information to assess the data sensitivity and the impact of data loss or exposure, as described above.

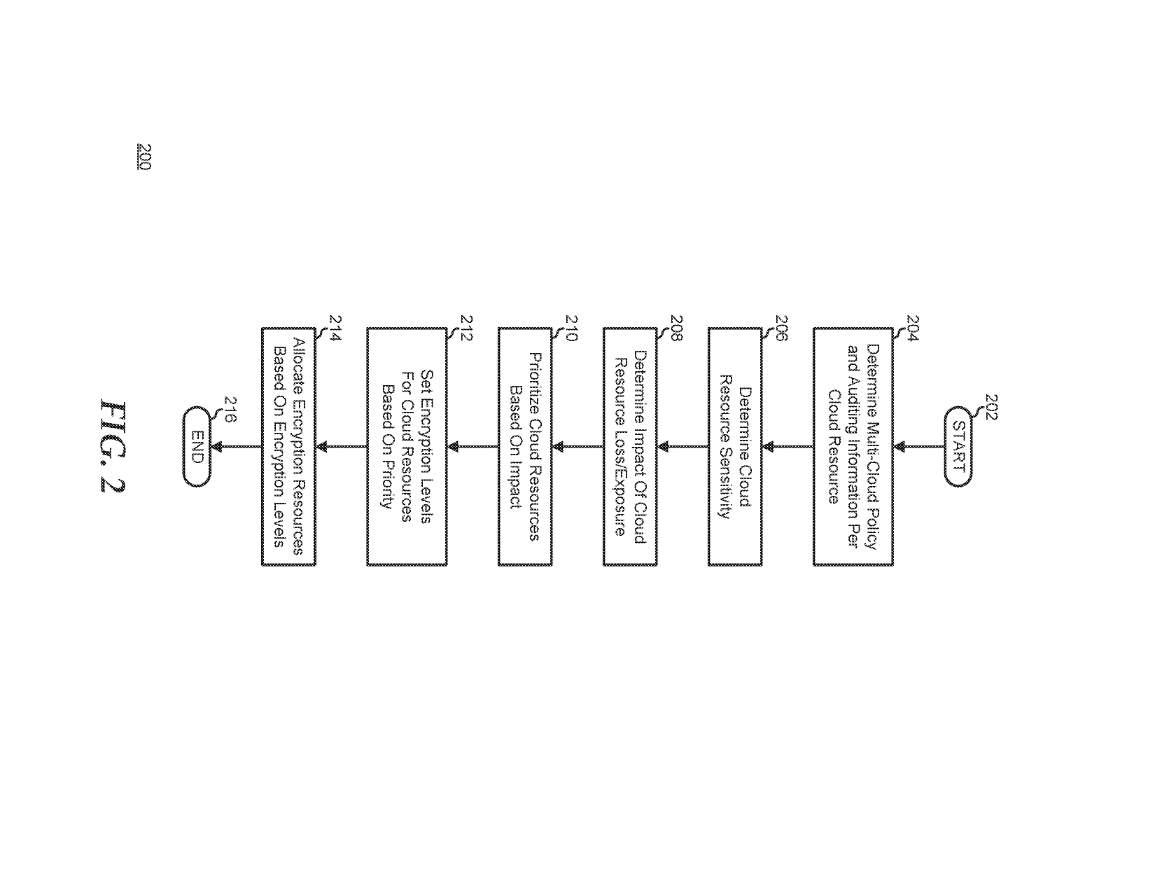

FIG. 2 illustrates a method 200 for providing a multi-cloud data security engine with contextual encryption and loss impact-based assessment, starting at block 202. The policies and auditing information for the cloud resources of a multi-cloud environment are determined in block 204. The sensitivity of each of the cloud resources is determined in block 206, and the impact of each of the cloud resources to data loss or exposure is determined in block 208. The cloud resources are prioritized based on the impact assessment in block 210, and the encryption levels for each of the cloud resources are set based upon the prioritization in block 212. Encryption resources are allocated for the cloud resources based on the encryption levels in block 214, and the method ends in block 216.

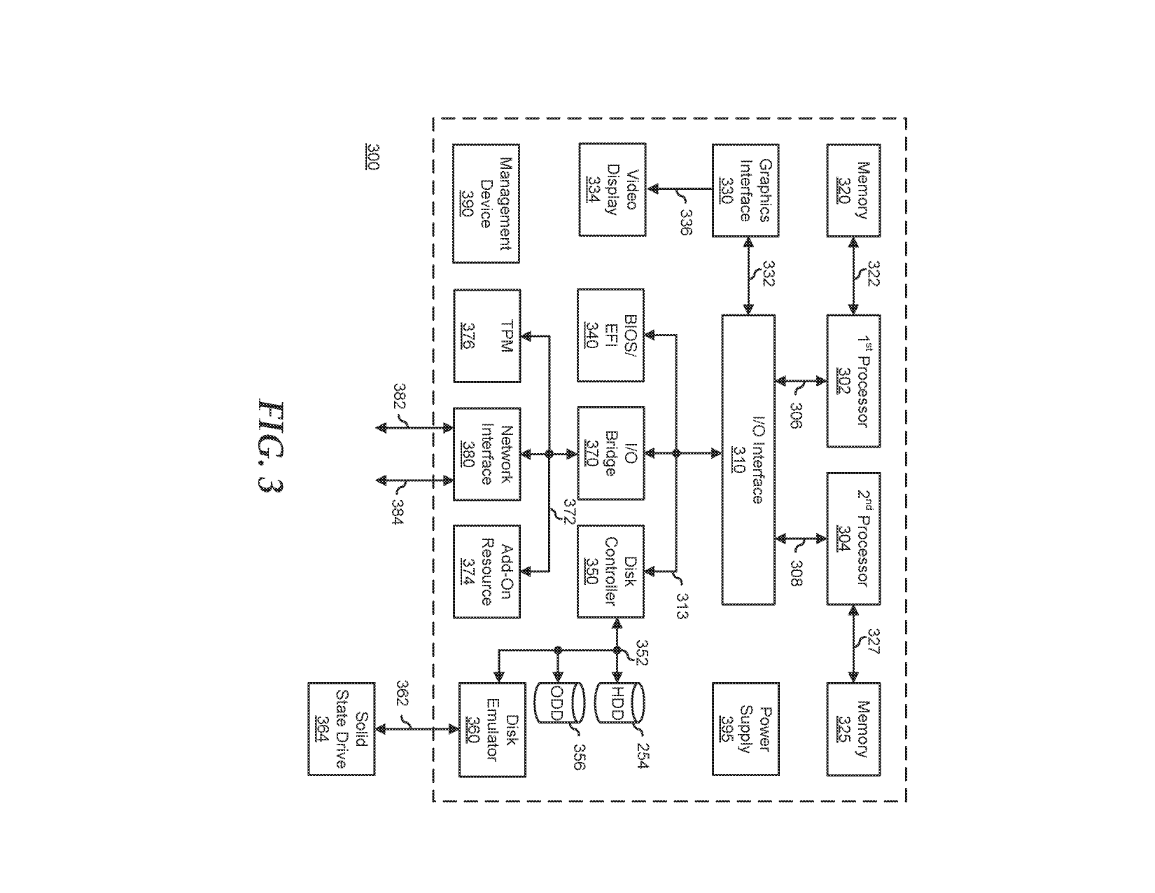

FIG. 3 illustrates a generalized embodiment of an information handling system 300 similar to information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356 , a disk emulator 360 connected to an external solid state drive (SSD) 362, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356 , disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 where peripheral interface 372 and the I/O channel are of the same type, and the I/O bridge translates information from a format suitable to the I/O channel to a format suitable to the peripheral channel 372 where they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 where the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed:

1. An information handling system, comprising:
a memory device to store code; and
a processor to execute code to determine a sensitivity level for each of a plurality of cloud resources, determine an encryption level for each of the cloud resources based on the sensitivity level, and encrypt data transfers between the information handling system and each of the cloud resources based on each cloud resource’s encryption level.

2. The information handling system of claim 1, wherein the sensitivity level for each of the cloud resources is based upon an associated data access policy for each cloud resource.

3. The information handling system of claim 1, wherein the sensitivity level for each of the cloud resources is based on an associated auditing requirement for each cloud resource.

4. The information handling system of claim 1, wherein the sensitivity level for each of the cloud resources is based on an associated data utilization metric for each cloud resource.

5. The information handling system of claim 1, wherein the processor is further configured to determine an impact level for each of the cloud resources.

6. The information handling system of claim 5, wherein the encryption level for each of the cloud resources is further based on the impact level of each associated cloud resource.

7. The information handling system of claim 6, wherein the impact level for each of the cloud resources is based on an associated impact of data loss for each cloud resource.

8. The information handling system of claim 6, wherein the impact level for each of the cloud resources is based on an associated impact of data corruption for each cloud resource.

9. The information handling system of claim 1, wherein the cloud resources are included in a plurality of cloud environments.

10. A method, comprising:
determining, by an information handling system, a sensitivity level for each of a plurality of cloud resources;
determining an encryption level for each of the cloud resources based on the sensitivity level; and
encrypting data transfers between the information handling system and each of the cloud resources based on each cloud resource’s encryption level.

11. The method of claim 10, wherein the sensitivity level for each of the cloud resources is based upon an associated data access policy for each cloud resource.

12. The method of claim 10, wherein the sensitivity level for each of the cloud resources is based on an associated auditing requirement for each cloud resource.

13. The method of claim 10, wherein the sensitivity level for each of the cloud resources is based on an associated data utilization metric for each cloud resource.

14. The method of claim 10, wherein the processor is further configured to determine an impact level for each of the cloud resources.

15. The method of claim 14, wherein the encryption level for each of the cloud resources is further based on the impact level of each associated cloud resource.

16. The method of claim 15, wherein the impact level for each of the cloud resources is based on an associated impact of data loss for each cloud resource.

17. The method of claim 15, wherein the impact level for each of the cloud resources is based on an associated impact of data corruption for each cloud resource.

18. The method of claim 10, wherein the cloud resources are included in a plurality of cloud environments.

19. An information handling system, comprising:
a memory device to store code; and
a processor to execute code to determine a sensitivity level for each of a plurality of cloud resources, determine an impact level for each of the cloud resources, determine an encryption level for each of the cloud resources based on the sensitivity level and the impact level, and encrypt data transfers between the information handling system and each of the cloud resources based on each cloud resource’s encryption level;
wherein the sensitivity level for each of the cloud resources is based upon one of an associated data access policy for each cloud resource, an associated auditing requirement for each cloud resource, and an associated data utilization metric for each cloud resource; and
wherein the impact level for each of the cloud resources is based on one of an associated impact of data loss for each cloud resource and an associated impact of data corruption for each cloud resource.

20. The information handling system of claim 19, wherein the cloud resources are included in a plurality of cloud environments.
